(19) United States
(12) Patent Application Publication
(10) Pub. No.: US 2007/0009101 A1
(43) Pub. Date: Jan. 11, 2007

(54) Method for allocating secured resources in a security module

(75) Inventors: Rached Ksontini, Lausanne (CH); Stephane Joly, Epesses (CH); Renato Cantini, Belfaux (CH); Mehdi Tazi, Morocco (CH)

Correspondence Address: HARNESS, DICKEY & PIERCE, P.L.C., P.O. BOX 8910, RESTON, VA, 20195, US

(73) Assignees: NAGRACARD S.A., Cheseaux-sur-Lausanne (CH); SWISSCOM MOBILE AG, Berne (CH)

(21) Appl. No.: 10/562,036

(22) PCT Filed: Jun. 22, 2004
(86) PCT No.: PCT/EP04/51198

§ 371 Date: Jul. 10, 2006

(30) Foreign Application Priority Data
Jun. 25, 2003 (EP) 03014209.5

(51) Int. Cl. H04K 1/00

(52) U.S. Cl. 380/247

(57) ABSTRACT

The aim of this invention is to provide a method to allocate resources on a security module of a portable apparatus such as a telephone, taking into account the security imperatives of the different intervening parties, such as the operator and application suppliers. This aim is achieved by a resource allocation method of a security module of an apparatus connected to a network, this network being administrated by an operator, said resources being used by the application suppliers, this method comprising the following steps: generation of a pair of asymmetric keys and storage of the private key in the security module, the public key being stored by the operator, introduction of at least one public key of the operator in the security module, reception by the operator of a request from a supplier, this request comprising at least the public key of the supplier, transmission by the operator of a resource reservation instruction to the security module together with the public key of the supplier, transmission by the operator of the security module's public key to the supplier, establishment of a secure communication channel between the supplier and the security module.

The present invention relates to the field of wireless telephony also known as cellular telephony. More particularly it concerns improving functions involving security mechanisms opened to specific application suppliers.

The security module of a mobile phone, better known as a “SIM card”, is the core of the security of such phones. During manufacture or during a personalisation stage the telephony operator introduces the necessary data to securely identify any telephone wishing to connect to its network.

In this respect, it includes at least a unique number and a cryptographic key allowing the secure identification of the SIM card.

While this card was initially only conceived for the telephony service, new applications have appeared such as the display of stock market prices or the weather forecast.

To achieve this type of application, a first model is that the supplier provides this data via the operator, which transmitted said data to the corresponding telephones.

While this solution applies for general data such as the weather forecast, it is inappropriate with respect to sensitive data such as a bank statement. Consequently this kind of service faces a confidentiality problem, since it is unacceptable for this type of data to have to pass through the mobile phone operator.

Another approach was to give the suppliers cryptographic means (particularly keys) to access the SIM card securely. This approach faces the inverse of the previous problem, i.e. the transmission of the operator's confidential data to a supplier, which is unacceptable to the operator.

U.S. Pat. No. 6,385,723 describes a solution where the applications are loaded into an electronic card (IC card). The method described consists in authenticating the applications to be loaded by an authority (Certification Authority) before such an application can be loaded into a card. Although this method assures greater security, it does not offer any flexibility and requires the intervention of the authority to carry out any change in the application.

EP 0 973 135 is also an illustration of the prior art. A specialised machine is provided to update the security parameters. It is rather a security module initialization carried out outside a protected zone. No indication allowing the update or the cancellation of subsequently loaded applications is described in this document.

Therefore, the aim of the present invention is to suggest a method that takes into account the security imperatives of the different intervening parties and that allows to offer the downloading and management of the security application on a mobile phone in a decentralised way.

This aim is achieved by a resource allocation method of a security module in an apparatus connected to a network, this network being administrated by an operator, said resources being used by application suppliers, this method comprising the following steps:
generation of a pair of asymmetric keys and storage of the private key in the security module, the public key being stored by the operator,
introduction of at least one public key of the operator in the security module,
reception by the operator of a supplier's request, this request including at least the supplier's public key,
transmission by the operator of a resource reservation instruction to the security module, together with the supplier's public key,
transmission by the operator of the security module's public key to the supplier,
establishment of a secure communication channel between the supplier and the security module,
loading of an application into the security module by the supplier.

This method presents the advantage of allocating resources in a controlled way since the reservation, i.e. blocking a resource, is under the control of the operator, while the exploitation of this resource is under the control of the supplier, without the operator having access to the exchanged data.

A resource is a memory area of a security module wherein one part could be made up of a programme and another part made up of data.

The processor of the security module executes securely the resource's programme i.e. the execution cannot call out ranges from the memory area out of the resource area.

Thanks to this resource, a supplier can for example store the banking account number and identify the account holder.

If the operator wishes to cancel a resource, he/she is the only one able to communicate with the security module at the level of resource management. The blockage or release of a resource leads to the deactivation or deletion of the whole memory zone specific to this resource, and in particular the deactivation or deletion of the corresponding supplier's public key.

The physical or virtual cancellation of this public key forbids any new reciprocal authentication between the supplier and the security module, and at the same time prevents any updating or any new downloading of the application by the same supplier in this blocked or deleted resource. The resource area includes a managing part wherein the definition for the use of each area is found.

This managing part is controlled by the operator. It includes the supplier's identifier, the supplier's key, and data allowing the addressing of the memory zone. This part can also include date indications in case the supplier or the final user is allowed to use the resource during a limited period. After this date, the resource is deactivated or deleted, and in particular the supplier's public key is deactivated or deleted.

According to another embodiment, this part can also comprise indications about a number of executions, in case the supplier or the final user is able to use the resource for a limited number of executions. Once this number of executions has been exceeded, the resource is deactivated or deleted, and in particular the supplier's public key is deactivated or deleted.

The invention will be better understood thanks to the following detailed description in reference to the enclosed drawings, which are given as a non-limitative example, namely:

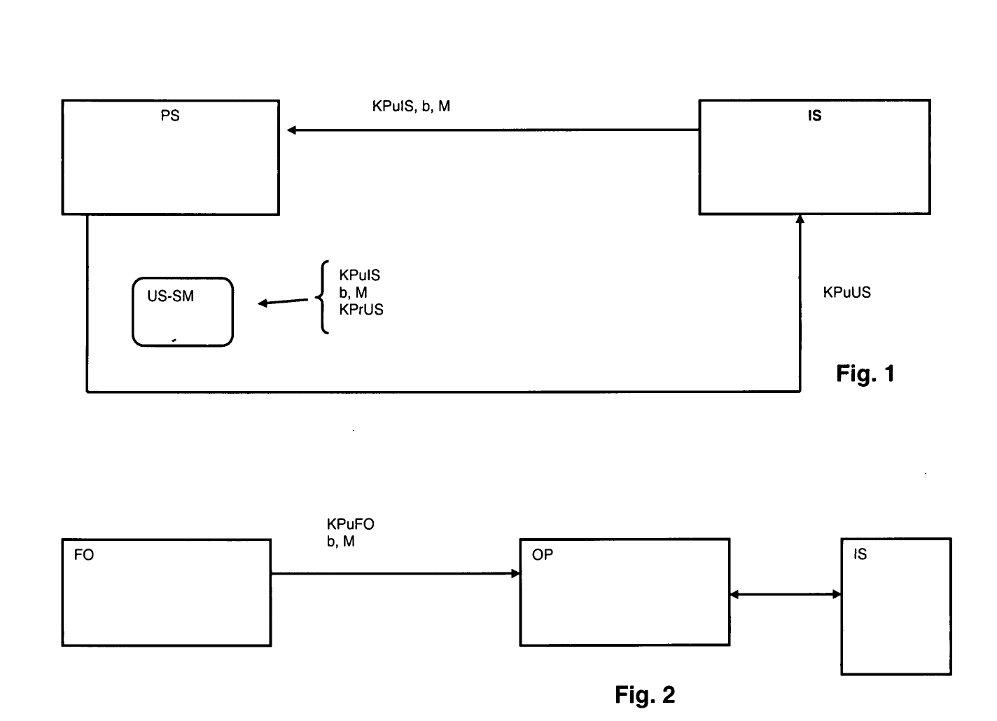

FIG. 1 shows the personalization step of a security module,

FIG. 2 shows the transmission between a supplier and an operator,

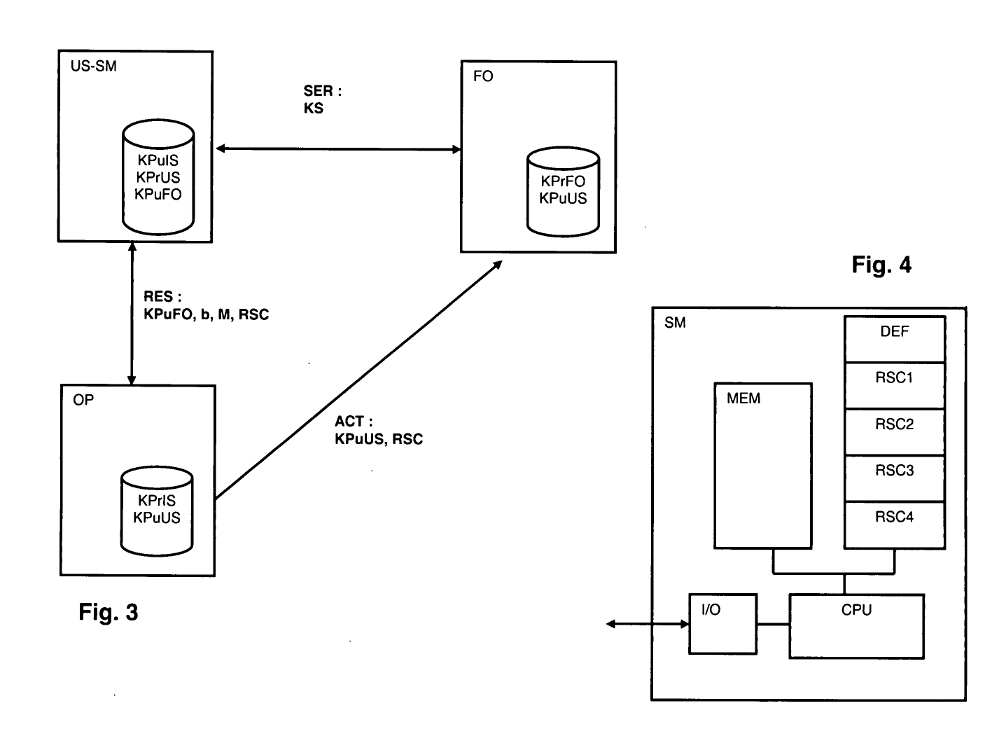

FIG. 3 shows data exchanges between the three entities,

FIG. 4 shows a security module for resource allocation.

According to FIG. 1, the initialization of a security module US-SM is carried out by a PS entity such as security module manufacturer. This PS entity places a public key KPuIS corresponding to the authority managing these modules, as well as a private key KPrUS corresponding to this security module.

As will be described below, other personalization parameters, such as generation data b, M (base and module) serving to generate a symmetrical key, can be also stored in the security module.

The personalization entity PS sends the personalization indications to the authority, namely for a given module (generally identified by a single address or a single identifier), its public key KPuUS. Other data, such as the characteristics of the module, for example its memory size and its cryptographic modules, are also memorised by the authority.

FIG. 2 shows the resource request operation by a supplier FO to the operator OP.

In order to be able to access to the resources of a security module, a supplier FO takes contact with the operator OP in a first phase. Then the supplier FO and the operator OP agree about the modalities of their partnership. According to our example, the operator OP requests the necessary data from the authority IS; the operator OP and the authority IS being two different entities. In another case, it is possible for the operator OP to comprise the functionality of the authority IS.

The supplier FO transmits, among other things, its public key KPuFO to the operator OP and informs about characteristics of the necessary resource. Data b, M serving for the generation of a symmetrical key can also be transmitted at this point.

FIG. 3 shows three operations: SER, RES and ACT.

The reservation step RES consists in creating a resource in a security module. A subscriber, via his security module US-SM, can emit a request to the operator OP to take advantage of the services proposed by the supplier FO. In such a case, the operator OP recovers the public key KPuFO from the supplier FO and then initiates a resource reservation operation RSC in the security module. The operator has data relating to the use of the resources for each security module. The operator can determine, according to the type of requirements of the supplier's FO, the most appropriate resource, for example according on the size of the required memory space.

The operator sends a reservation command to the security module, this command of course being secured by the private key KPrOP of the operator. This command reserves a resource, namely a part of the memory area receives the data that can be used to authorize a dialogue with a supplier. During this operation, the security module receives the public key KPuFO from the supplier, the key that will allow the establishment of a security connection with this supplier.

During this operation, if the operator does not have the key of the security module, the operator may request said key from the authority IS. This request between these two entities is of course made securely.

The second step ACT consists in transmitting the data from a subscriber or security module to a supplier FO. The operator OP communicates the public key KPuUS and the identification of the resource RSC that has been allocated.

The fact that the public key of each security module is unique means that the operator OP or the authority IS, once the security module US-SM has been identified, searches in its database for the public key KPuUS for this module and transmits said key to the supplier.

After this initialization, the step SER i.e. the use of this service can be activated and the user can call a specialised number that will connect him directly to the supplier. The latter will load, as a first task, the application in the security module US-SM in the memory zone where it had been allocated by the operator. A session key KS is generated for the secure exchange of codes and/or data.

FIG. 4 shows the organisation of the security module. The latter comprises a run unit CPU, a working memory MEM, wherein the module operating programme and a memory zone intended for external resources is stored. This zone comprises a first part known as definition DEF, which contains data defining a resource RSC1 to RSC4. In practice, the memory zone for the resources is not necessarily divided in advance. When a supplier requests a resource from the operator, it can also specify the necessary memory size. Thus, the resource memory zone can contain more resources as long as each resource only uses a small amount of memory. The definition part DEF contains the start and end instructions for each resource.

Supplementary data indicating, for example, the access rights to certain programming interfaces (libraries) available on the security module US-SM, such as cryptographic algorithms or other of particular calculation processes, can be associated to each resource RSC. This type of data can be backed up for example in the zone DEF or in the zone RSC respectively.

The I/O module schematises the communication with the host apparatus such as a mobile telephone.

There are several methods for the establishment of a secure connection between two entities. Within the context of the invention, the use of an asymmetric pair of keys is provided, the main entity having the private key and the third entity receiving the public key. In principle the private key is not sent by telecommunication means, but rather is directly introduced into the device during a secure initialization phase. The public key is sent according to the scenarios described above in order to dialogue with this device.

In practice, the exchange of a public key is often made with the aid of a certificate associated to this key. When entity B receives the public key from entity A, this key is included in a certificate that has been signed by an authority trusted by entity A, for example by the operator. In certain cases, it may be that entities A and B are previously authenticated and that the channel through which they communicate is sufficiently secure to be able to transmit a public key without any certificate.

Asymmetric keys, such as keys RSA, allow the authentication of the partners. Entity A is authenticated by means of an operation using its own private key KPrA. Entity B can then verify the validity of this authentication with the aid of the corresponding public key KPuA. The encryption based on asymmetric keys is hard and involves important cryptographic means. It is for this reason that asymmetric keys are generally used for authentication and generation of a symmetrical session key. It is also possible to use the asymmetric keys for authentication and to use the method described by Diffie & Hellmann for the generation of a symmetrical session key.

According to one of the embodiments, the resource reservation stage comprises, in addition to the sending of the public key KpuFO of the supplier, the sending of the Diffie & Hellmann parameters, namely the module M and the base b pertaining to the supplier. Therefore, during the establishment of a session key between the supplier and the security module of a subscriber, these parameters will be used without it being necessary to transmit said parameters again.

It is possible to use the same method as Diffie & Hellmann in order to generate a session key between the security module and the operator, the initialization stage of the security modules can comprise in this case a supplementary stage that consists in introducing the Diffie & Hellmann parameters pertaining to the operator in the security module.

According to a first form for establishing a secure connection, the exchange of data between both devices will use the public key of the other device. This procedure has the advantage that the generation of a symmetrical key KS that allows the securing of the exchanges is carried out simultaneously to the authentication of the partners is carried out.

According to a second form for establishing a secure connection, a session key is generated as usual between entities A and B based on the parameters Diffie & Hellmann. Once this session key has been established, a reciprocal authentication procedure is initiated. For example, entity A can sign with the aid of its private key KPrA certain values exchanged with B during the Diffie & Hellmann negotiation, and send to B the signature generated in this way. Entity B can then authenticate A by verifying the signature with the aid of the key KPuA. Similarly, entity B can sign with the aid of its private key KPrB certain values exchanged with A during the Diffie & Hellmann negotiation, and send to A the signature generated in this way. Entity A can then authenticate B by verifying the signature with the aid of the key KPuB.

There are also other methods for establishing this type of secure connection, for example by inverting the two previous steps, that is to say, by using the cryptography of the public/private key to authenticate both partners and then generate the session key.

In practice, the different entities can intervene in the different steps. The generation of the keys is entrusted to a first authority that communicates said keys, at least the private part, to an integrator in view of the personalization of the security units. It should be noted that this generation can be carried out directly in the security module and that only the public key is communicated during an initialization stage in a secure environment.

This database of public keys associated to the unique number (UA) of each security module can be controlled by the operator or can be delegated to a third entity. It is this entity that assures the resource allocation functions instead of the operator.

In another embodiment of the invention, it is desirable for the loading of an application to be carried out globally. Due to the fact that the security modules each use a unique key, an intermediate step is added during the reservation of the resource. A domain key is added to the parameters transmitted by the operator OP to a security module, said key is common to all the security modules for any given application. The definition of the resource is specific to each security module according to its material capacity, but once defined it receives a logic name that is common to all the modules as well as to a common key. The supplier FO can thus simultaneously download its application in all the connected modules either in diffusion mode, or by an independent procedure of the security module, when this module calls the supplier's server. This domain key DK can either be symmetrical or asymmetrical according to the method of implementation. This key replaces the pair of public/private keys of the security module while establishing the security connection.

1. Resource allocation method for a security module of an apparatus connected to a network, this network being administrated by an operator, said resources being used by application suppliers, the method comprising:
generating a pair of asymmetric keys and storage of the private key in the security module, the public key being stored by an authority;
introducing at least one public key of the authority in the security module;
receiving, by the operator, a request from a supplier and transmission of the request to the authority, this request comprising at least the supplier's public key;
transmitting, by the authority of at least the public key of the supplier to the operator;
transmitting, by the operator, a resource reservation instruction to the security module together with the supplier's public key;
transmitting, by the operator of the public key of the security module, to the supplier;
establishing a secure communication channel between the supplier and the security module;
loading of an application in the security module by the supplier; and
at least one of deactivating and clearing, by the operator, of at least part of the memory zone dedicated to a predefined resource when the clearing conditions are met.

2. Resource allocation method according to claim 1, wherein the pair of asymmetric keys is generated by the security module, the public key then being transmitted to the authority.

3. Resource allocation method according to claim 1, wherein the initialization parameters of a session key pertaining to the operator are stored in the security modules during the initialization.

4. Resource allocation method according to claim 1, wherein the supplier transmits the initialization parameters of a session key to the operator, these parameters being transmitted to the security module during the reservation of a resource.

5. Resource allocation method according to claim 1, wherein the establishment of a secure communication between the supplier and the security module is based on the use of the supplier's public key by the security module and the use of the security module's public key by the supplier.

6. Resource allocation method according to claim 3, wherein the establishment of a secure communication between the operator and the security module is based on the generation of a session key using the initialization parameters of the operator.

7. Resource allocation method according to claim 4, wherein the establishment of a secure communication between the supplier and the security module is based on the generation of a session key using the initialization parameters of the supplier.

8. Resource allocation method according to claim 1, wherein the authority and the operator form the same entity.

9. Resource allocation method according to claim 1, wherein the resource reservation instruction includes the sending of a domain key, which is specific to an application and common to all the security modules having this application, this key being used for the establishment of a secure communication between the supplier and the security module.

10. Resource allocation method according to claim 1, wherein the deactivating or clearing of at least part of the memory zone dedicated to a predefined resource consist in clearing at least the public key of the supplier.

11. Resource allocation method according to claim 1, wherein the clearing conditions are met when the resource has been executed a number of time equal or greater than a predefined limit.

12. Resource allocation method according to claim 1, wherein the clearing conditions are met when the resource has been executed a during a time equal or greater than a predefined time limit.
